(19) United States
(12) Patent Application Publication
(10) Pub. No.: US 2026/0233463 A1
(43) Pub. Date: Aug. 13, 2026

(54) MULTI-COMPONENT ADDITIVE MANUFACTURING DEVICE

(71) Applicant: PPG Industries Ohio, Inc., Cleveland, OH (US)

(72) Inventors: Bret Michael Boyle, Pittsburgh, PA (US); Christian Cancino, Philadelphia, PA (US); Anthony Jared Fogl, Pittsburgh, PA (US)

(73) Assignee: PPG Industries Ohio, Inc., Cleveland, OH (US)

(21) Appl. No.: 19/157,020

(22) PCT Filed: Dec. 11, 2023
(86) PCT No.: PCT/US2023/083336

§ 371 Date: Aug. 15, 2025

Related U.S. Application Data
(60) Provisional application No. 63/485,140, filed on Feb. 15, 2023.

(51) Int. Cl. B29C 64/314; B29C 64/106; B29C 64/209; B29K 101/10; B33Y 10/00; B33Y 30/00; B33Y 40/10

(52) U.S. Cl. CPC B29C 64/314; B29C 64/106; B29C 64/209; B33Y 10/00; B33Y 30/00; B33Y 40/10; B29K 2101/10

(57) ABSTRACT

An additive manufacturing device that mixes a plurality of coreactive components and extrudes a printable thermoset composition. The additive manufacturing device comprises at least three pumping arrangements, each of the at least three pumping arrangements configured to dispense a respective printable component; a mixing arrangement fluidly coupled to each of the at least three pumping arrangements, the mixing arrangement comprising: a mixing volume; and a mechanical mixer positioned within the mixing volume, and a print nozzle fluidly coupled to the mixing arrangement configured to extrude the printable components during an additive manufacturing process.

### CROSS-REFERENCE TO RELATED APPLICATIONS

This application claims the benefit under 35 U.S.C. § 119 (e) of U.S. Provisional Application No. 63/485,140 entitled “MULTI-COMPONENT ADDITIVE MANUFACTURING DEVICE”, filed on Feb. 15, 2023, which is incorporated by reference in its entirety.

### GOVERNMENT LICENSE RIGHTS

This invention was made with government support under Government Contract No. W911NF-17-2-0227 (Army Research Laboratory, US ARMY). The government may have certain rights in the invention.

### FIELD

The present disclosure relates to an additive manufacturing device that mixes a plurality of coreactive components and extrudes printable compositions.

### BACKGROUND

3D printing is a process that is used to create objects out of cured compositions, such as plastics. The cured composition can be made of a thermoset composition. During the printing of the object using a thermoset composition, at least two coreactive components are mixed together to create a coreactive composition. The thermoset composition may be used in ambient reaction extrusion (ARE) printing, in which the coreactive composition is deposited onto a printing platform using an additive manufacturing device and cured at ambient conditions.

Different coreactive components make different thermoset compositions that vary in physical properties. It can be time consuming to load different coreactive components into the additive manufacturing device to create a 3D object made of multiple thermoset compositions.

### SUMMARY

The present disclosure provides an additive manufacturing device comprising at least three pumping arrangements, each of the at least three pumping arrangements configured to dispense a respective printable component; a mixing arrangement fluidly coupled to each of the at least three pumping arrangements, the mixing arrangement comprising: a mixing volume; at least three fluid channels, wherein each one of the at least three fluid channels is fluidly coupled with one of the at least three pumping arrangements, and the respective printable component dispensed by each of the at least three pumping arrangements flows into the mixing volume through the fluid channel fluidly coupled to the pumping arrangement; and a mixer positioned within the mixing volume, the mixer configured to mix the printable components dispensed from the at least three pumping arrangements; a print nozzle fluidly coupled to the mixing arrangement configured to extrude the printable components during an additive manufacturing process.

The present disclosure also provides a mixing arrangement used in an additive manufacturing process, the mixing arrangement comprising: a mixing volume; at least three passageways fluidly coupled with the mixing volume, wherein each of the at least three passages conveys a printable composition into the mixing volume; and a mixing device, and wherein at least two of the printable compositions conveyed by the at least three passageways comprise coreactive components that react and cure under ambient conditions, and during the additive manufacturing process, the at least two coreactive components are substantially simultaneously conveyed into the mixing arrangement and are mixed by the mixing device prior to being discharged from the mixing arrangement.

The present disclosure also provides a method of additive manufacturing comprising: combining a first coreactive component and a second coreactive component in a mixing arrangement, the first coreactive component and the second coreactive component reacting to form a first printable composition; extruding the first printable composition from the mixing arrangement through a print nozzle; flushing the print nozzle with a non-coreactive component; combining a third coreactive component and a fourth coreactive component in the mixing arrangement, the third coreactive component and the fourth coreactive component reacting to form a second printable composition; and extruding the second printable composition through the print nozzle.

The present disclosure also provides a method of additive manufacturing comprising: combining a first coreactive component and a second coreactive component in a mixing arrangement, the first coreactive component and the second coreactive component reacting to form a first printable composition; extruding the first printable composition from the mixing arrangement through a print nozzle; combining the first coreactive component and a third coreactive component in the mixing arrangement, the first coreactive component and the third coreactive component reacting to form a second printable composition, the second printable composition sharing a coreactive chemistry with the first printable composition; and extruding the second printable composition through the print nozzle.

### BRIEF DESCRIPTION OF THE DRAWINGS

FIG. 1 is a perspective view of an additive manufacturing device;

FIG. 2 is a bottom view of the additive manufacturing device of FIG. 1;

FIG. 3 is a front perspective view of the additive manufacturing device of FIG. 1;

FIG. 4 is a cross-sectional view along axis A of the additive manufacturing device of FIG. 3;

FIG. 5 is a cross-sectional view along axis A of the additive manufacturing device of FIG. 3;

FIG. 6 is a front perspective view of a mixing arrangement within a diamond mount of the 5 additive manufacturing device of FIG. 1;

FIG. 7 is a top perspective view of the diamond mount of FIG. 6;

FIG. 8 is a perspective view of an impeller of the additive manufacturing device of FIG. 1;

FIG. 9 is a flowchart illustrating a method of printing a 3D object using the additive manufacturing device of FIG. 1; and

FIG. 10 is a flowchart illustrating a method of printing a 3D object using the additive manufacturing device of FIG. 1.

### DETAILED DESCRIPTION

The present disclosure provides an additive manufacturing device and methods of using the device to make 3D printed objects.

### I. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges from (and including) the recited minimum value of 1 to the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

“Polymer” and “Polymeric” refers to oligomers, homopolymers (e.g., prepared form a single monomer species), copolymers (e.g., prepared form at least two monomer species), terpolymers (e.g., prepared from at least three monomer species), and graft polymers.

“Printing” refers to any process in which a material is deposited onto and/or reacted with another material and/or itself, for example three-dimensional printing.

“Coreactive composition” refers to a composition comprising at least two different compounds capable of chemically reacting with each other to form covalent bonds.

“Coreactive component” refers to a compound containing at least one reactive functional group, that when combined with a chemically compatible functional group, react to form a coreactive composition.

“Reactive functional group” refers to a chemical group capable of chemically reacting with another reactive functional group to form a covalent bond.

“Reactive compound” refers to a compound comprising at least one reactive functional group.

“Extrusion” refers to a process used to create objects in which material is pushed through a die. An extrusion die has a shape and dimensions suitable to build an object. An extrusion die may have a fixed shape or a shape that can be changed during extrusion.

“Filler” refers to any compound added to a reactive compound or coreactive composition that is nonreactive with at least a part of the compound and/or composition. Fillers as used herein encompasses particulates, fibers, slurries, mixtures, and any other compound and combinations thereof that may be added to a reactive compound and/or coreactive composition.

“ARE” or ambient reactive extrusion refers to any additive manufacturing of coreactive compositions including coreactive components.

“Ambient conditions” refers to conditions typical for a temperature-controlled environment located indoors. Herein, ambient conditions may describe an environment experiencing ambient temperature, barometric pressure, and/or relative humidity values typical for the interior space of a building, such as temperature values as low as 20° C., 21° C., or 22° C., as high as 28° C., 29° C., or 30° C., or between any of the two foregoing values used as endpoints, such as 20° C. to 30° C., or 22° C. to 27° C.; barometric pressure values as low as 0.85 atm, 0.90 atm, as high as 1.0 atm or 1.05 atm, or between any of the two foregoing values used as endpoints, such as 0.85 atm to 1.05 atm and 0.95 atm to 1.0 atm; and/or relative humidity values as low as 25%, 35%, or 45% or 50%, as high as 55%, 80%, or 95%, or between any of the foregoing values used as endpoints, such as between 25% to 95%, 40% to 80%, or 50% to 75%.

### II. Coreactive Chemistries

Additive manufacturing using coreactive compositions, also referred to as ambient reactive extrusion, or ARE type three-dimensional printing, typically utilizes at least two components that react with each other (e.g., are coreactive). A first coreactive component (sometimes referred to herein as a first reactant group, a first reactive functional group, part A, and/or a first printable coreactive component) and at least one second coreactive component (sometimes referred to herein as a second reactant group, second reactive functional group, part B, and/or a second coreactive component), when extruded in combination and/or succession, chemically react with one another to form a coreactive composition (sometimes referred to herein as a printable composition). The coreactive composition may thereafter cure under ambient conditions or, depending on the chemistry of the reaction, with the assistance of, for example, heat, actinic radiation (e.g., Ultraviolet radiation), catalysts, addition of curing agents-post extrusion, etc. to form an object, or a portion of an object, comprising a thermosetting polymer (sometimes referred to as a thermoset), a thermoplastic polymer, or combinations thereof. At least the first coreactive component and the second coreactive component are chosen by one skilled in the art to result in the desired final product (e.g., thermoset, thermoplastic, etc.).

Three dimensional objects formed from coreactive compositions are additively manufactured by extruding the coreactive composition, which may be in an at least partially reacted state, onto a surface, such as a build platform. The coreactive composition may be in an at least partially reacted state at the time of extrusion and thereafter fully react and cure to form a layer of the coreactive composition. Successive layers of either the same, or different coreactive compositions can be deposited, forming additional layers of material. The coreactive composition may be at least partially reacted when the coreactive components come together, such as in a mixing volume, just prior to extrusion. Alternatively, the two coreactive components could be premixed before extrusion and treated in a way to arrest the reaction (e.g., arrest curing of the coreactive composition), such as freezing the mixture upon mixing.

It may be desirable to select the chemistry of each layer of the deposited coreactive composition such that covalent bonds between each successive layer of material are formed. Furthermore, different portions of the article can be printed from different coreactive compositions (e.g., a first coreactive composition printed to form a first portion of the object such as a base portion, an internal structure, etc., and a second coreactive composition printed to form a second portion of the object), and, depending on the chemical reactivity between the different coreactive compositions, covalent bonds might also form between different materials.

Specifically, an article may be printed so as to have a rigid portion and a flexible portion, a rigid portion and a foam-like portion, a tactile portion and a rigid and/or flexible portion, two portions comprising different densities, one or more conductive portions, one or more thermally/electrically conductive portions, two or more different colors, two or more different rheological profiles, two or more different materials comprising different affinities for water and/or solvent(s), and the like. The article may also be printed such that the coreactive compositions are deposited onto existing articles (e.g., other thermosets and/or thermoplastics, metals, woods, composite materials, ceramics, etc.) resulting in an article comprising both coreactive and non-coreactive compositions.

Additive manufacturing as described herein may result in an object having greater strength, particularly along the Z (e.g., vertical) axis, as compared to other extruded or printed parts due to the covalent bonding between the printed layers. Strong intralayer and interlayer covalent bonding results in not only stronger parts, but also in more uniform part geometries; that is, less print lines and/or portion differentials. The ability to form, in one process, objects having multiple substrates and/or portions comprising different coreactive or non-coreactive compositions is a further advantage.

Table 1 describes suitable coreactive compositions and the coreactive components from which they can be formed. These coreactive compositions can be printed by any of the methods described herein, either alone or in combination, to form three dimensional objects.

TABLE 1
Coreactive Compositions

| Coreactive | First Coreactive Component | Second Coreactive Component |
|---|---|---|
| Composition | (e.g., Reactant Group A) | (e.g., Reactant Group B) |
| Polyurea-based | A polyisocyanate-containing | An amine-containing compound, |
| coreactive | compound, such as polyisocyanate | such as a polyamine including |
| composition | prepolymer(s), polyisocyanate | polyamine prepolymer(s), |
| | monomer(s), or blends thereof. | polyamine monomer(s), or blends |
| | | thereof. |
| Polythioether- | An epoxy-containing compound, | A thiol-containing compound, such |
| based coreactive | such as polyepoxide prepolymer(s), | as polythiol prepolymer(s), |
| composition | polyepoxide monomer(s) or blends | polythiol monomer(s), or blends |
| | thereof. | thereof. |
| Michael addition- | A Michael donor compound, such as | A Michael acceptor compound |
| based coreactive | prepolymers and/or monomers of a | including alpha and/or beta- |
| composition | thiol-containing compound, an | unsaturated compounds and |
| | amine-containing compound, and/or | electron withdrawing substituents, |
| | a carbanion-containing compound. | such as prepolymers, monomers, or |
| | | combinations thereof, of any one of |
| | | alpha and/or beta-unsaturated |
| | | aldehydes, alpha and/or beta- |
| | | unsaturated ketones such as |
| | | acrylates, maleates, fumarates, |
| | | and/or methacrylates, vinyl ester- |
| | | containing compounds, vinyl |
| | | sulfone-containing compounds, |
| | | imidazole- containing compounds, |
| | | and maleimide-containing |
| | | compounds. |
| Aza-Michael | A Michael donor compound such as | A Michael-acceptor compound |
| addition-based | prepolymers and/or monomers of a | including an alkene-containing |
| coreactive | amine-containing compound, such | compound, such as prepolymers, |
| composition | as a polyamine prepolymer(s), | monomers, or combinations |
| | polyamine monomer(s), or blends | thereof, of any one of alpha and/or |
| | thereof. | beta-unsaturated aldehydes, alpha |
| | | and/or beta-unsaturated ketones |
| | | such as acrylates, maleates, |
| | | fumarates, and/or methacrylates, |
| | | vinyl ester-containing compounds, |
| | | vinyl sulfone-containing |
| | | compounds, imidazole- containing |
| | | compounds, and maleimide- |
| | | containing compounds. |
| Thia-Michael | A Michael donor compound such as | A Michael-acceptor compound |
| addition-based | prepolymers and/or monomers of a | including an alkene-containing |
| coreactive | thiol-containing compound, such as | compound, such as prepolymers, |
| composition | polythiol prepolymer(s), polythiol | monomers, or combinations thereof |
| | monomer(s), or blends thereof. | of any one of alpha and/or beta- |
| | | unsaturated aldehydes, alpha and/or |
| | | beta-unsaturated ketones such as |
| | | acrylates, maleates, fumarates, |
| | | and/or methacrylates, vinyl ester- |
| | | containing compounds, vinyl |
| | | sulfone-containing compounds, |
| | | imidazole- containing compounds, |
| | | and maleimide-containing |
| | | compounds. |
| Polyurethane- | A hydroxyl-containing compound, | An isocyanate-containing |
| based coreactive | such as polyol prepolymer(s), polyol | compound, such as polyisocyanate |
| composition | monomer(s), or blends thereof. | prepolymer(s), isocyanate |
| | | monomer(s), or blends thereof. |
| Epoxy-amine- | An epoxy-containing compound, | An amine-containing compound, |
| based coreactive | such as polyepoxide prepolymer(s), | such as polyamine prepolymer(s), |
| composition | polyepoxide monomer(s), or blends | polyamine monomer(s), ketamine |
| | thereof. | prepolymer(s), ketamine monomer, |
| | | or blends thereof, and/or an amide- |
| | | containing compound, such as |
| | | polyamide prepolymer(s), |
| | | polyamide monomer(s), or blends |
| | | thereof. |
| Epoxy-anhydride- | An epoxy-containing compound, | An anhydride-containing |
| based coreactive | such as polyepoxide prepolymer(s), | compound, such as anhydride |
| composition | polyepoxide monomer(s), or blends | prepolymer(s), anhydride |
| | thereof. | monomer(s), or blends thereof. |
| Thiolene-based | A thiol-containing compound, such | An alkylene-containing compound, |
| coreactive | as polythiol prepolymer(s), polythiol | such as polyalkene prepolymer(s), |
| composition | monomer(s), or blends thereof. | polyalkene monomer(s), or blends |
| | | thereof. |
| Polysulfide-based | A catalyst and/or activator, such as | A thiol-containing compound, such |
| coreactive | an oxidizing compound, such as | as polythiol prepolymer(s), |
| composition | metalperoxides, metal oxy-salts, | polythiol monomer(s), or blends |
| | and/or other oxidizing agents, or | thereof. |
| | blends thereof. | |
| Condensation | An amine-containing compound, | An acetate-containing compound, |
| reaction-based | such as a polyamine prepolymer(s), | such as polyacetoacetate |
| coreactive | polyamine monomer(s), or blends | prepolymer(s), polyacetoacetate |
| composition | thereof. | monomer(s), or blends thereof. |
| Addition-cured | A multi-hydride-functional silicone | A multi-vinyl-functional silicone |
| Silicone | containing material such as | containing material such as |
| | polysiloxane or | polysiloxane or |
| | polydimethylsilicone polymers or | polydimethylsilicone polymers or |
| | oligomers or blends thereof. | oligomers or blends thereof. |
| Condensation- | A silanol-containing compound, | An acetoxy-, alkoxy-, oxime-, |
| cured Silicone | such as a silicone prepolymer(s), | acetone- containing compound, |
| | polysiloxane monomer(s), or blends | such as polymethoxy silane |
| | thereof. | prepolymer(s), polymethoxy |
| | | monomer(s), or blends thereof. |

Another advantage of additive manufacturing using coreactive compositions may be that the coreactive compositions can be three dimensionally printed at relatively low viscosity. Therefore, relatively large amounts (e.g., high relative weight percents) of additives and/or fillers can be included with the coreactive components while maintaining a printable viscosity. Both the type and/or the amount of additives can be selected or “tuned” to result in desirable chemical and/or physical properties of the printed article. Coreactive compositions can be tuned with the addition of additives and/or fillers for desired mechanical performance (e.g., strength, elasticity, rigidity, sag resistance, etc.), surface features (e.g., hardness, texturing, smoothness, etc.), chemical resistance (e.g., solvent resistance, etc.), thermal resistance (including fire retardancy, etc.) or conductivity, and/or electrical insulation or conductivity. Coreactive compositions can also be tuned with the addition of one or more catalytic/activator/accelerant additives in any of the printable coreactive components to result in desirable reaction kinetics, such as rate of reaction.

Table 2 describes additives that can be included with any coreactive compositions, such as those described in Table 1. The additives can be included in, either, or both of, the first and second coreactive components (e.g., either, or both of the Part A/Part B), depending on the desired chemical and/or physical properties of the resulting object. In this case, Table 2 describes specific additives and fillers that may be suitable for ambient reactive extrusion-based three-dimensional printing, however, Table 2 is non-limiting. Therefore, other additives may be included with the coreactive composition(s), such as additives known to those skilled in the coatings, extrusion, and thermoplastic areas.

TABLE 2
Additives/Fillers

| Function | Additive Categories |
|---|---|
| Catalysts | Oxidative catalysts, latent catalysts, basic catalysts, |
| | acidic catalyst, Lewis acidic catalysts, Lewis basic |
| | catalysts, hydrosilylation catalysts. |
| Activators | Inorganic activators, organic activators. |
| Accelerants | Triazine-based accelerants, thiazole-based |
| | accelerants, sulfide-based accelerants. |
| Pigments | Effect Pigments (e.g., additives that may affect |
| | appearance and/or performance), colorants, dyes. |
| Rheology Modifiers | Natural polymers, synthetic polymers, inorganic |
| | materials, thermoplastics, thermosets. |
| Organic/ | Clay-based fillers, talc-based fillers, silicas glass |
| Inorganic fillers | powders, mica-based fillers, diatomaceous earth- |
| | based fillers, calcium carbonate-based fillers. |
| Fire retardant fillers | Inorganic fire retardants, organic fire retardants. |
| Low-density fillers | Microcapsules, microspheres, microballoons, glass |
| | beads. |
| Conductive fillers | Thermally conductive fillers, electrically conductive |
| | fillers, magnetic fillers, EMI/RFI shielding fillers. |
| Adhesion promoters | Phenolic-based adhesion promoter, silane-based |
| | adhesion promoter. |
| Plasticizers | Phthalates, phenyls, benzoates, waxes, oils, non- |
| | reactive polymers. |
| Leveling additives | Silicone-based leveling agents, acrylate-based |
| | leveling agents, fluorocarbon-based leveling agents, |
| | hydrocarbon-based leveling agents. |
| Defoaming/ | Oil-based defoaming agents, powder-based |
| Deaerating | defoaming agents, water-based defoaming agents, |
| agents | silicone-based defoaming agents, and alkyl |
| | polyacrylate-based defoaming agents. |
| Surfactants | Anionic-based surfactants (e.g., sulfate, sulfonate, |
| | phosphate, carboxylate derivatives, etc.), cationic |
| | head group-based surfactants, amphoteric-based |
| | surfactants, non-ionic based surfactants. |
| Drying agents | Primary (e.g., active) drying agents, secondary (e.g., |
| | auxiliary) drying agents. |
| Dispersants | Polymeric dispersing agents, ionic dispersants, non- |
| | ionic dispersants, polyester-based dispersants, |
| | polyamide-based dispersants, polyglycol-based |
| | dispersants, fatty acid-based dispersants, polyether- |
| | based dispersants, polyurethane-based dispersants, |
| | polyacrylate-based dispersants. |
| Wetting agents | Silicone-based wetting agents, silicone free wetting |
| | agents (e.g., acetylenic, alkoxylate derivates, etc.), |
| | hydrocarbon based wetting agents, |
| | polymeric silicone free based wetting agent (e.g., |
| | acrylates, maleates derivatives, etc.), fluor-based |
| | wetting agents, organic-based wetting agents. |
| Light-stabilizing agents | Hindered amine-based compounds, UV absorber |
| | compounds, Quencher compounds. |
| Emulsifiers | Cationic-based emulsifiers, anionic-based |
| | emulsifiers, non-ionic emulsifiers. |
| Chelating agents | Organic compounds, inorganic compounds |
| Freeze-thaw | Glycol-based compounds, non-ionic compounds, |
| control agents | ether-based compounds. |
| Biocide agents | Heavy metals (e.g., silver), formaldehyde and/or |
| | formalin-based compounds, formaldehyde donor - |
| | based compounds (e.g., triazines), organosulfur- |
| | based compounds, isothiazoline-based compounds, |
| | pyridine derivative- based compounds, organic acid |
| | and/or salt-based compounds, nitrogen-based |
| | compounds, phenolic-based compounds. |
| Heat stabilizing agents | Organotin-based heat stabilizers, alkyltin |
| | intermediates, organic compounds, organometallic |
| | compounds, metallic soaps. |
| Corrosion inhibiters | Zinc phosphate-based corrosion inhibitors, Lithium- |
| | phosphate-based corrosion inhibitors, chromate- |
| | based corrosion inhibitors. |
| Moisture scavengers | zeolite, alumina, silica, calcium oxide, magnesium |
| | oxide, molecular sieve, anhydrous sodium sulphate, |
| | anhydrous magnesium sulphate, alkoxysilanes. |
| Intumescent materials | Melamine-based materials, ammonium |
| | polyphosphate-based materials, and expandable |
| | graphite-based materials. |
| Thermally conductive, | A pigment, filler, or inorganic powder that has a |
| electrically insulative | thermal conductivity of at least 5 W/m · K at 25° C. |
| materials | (measured according to ASTM D7984) and a volume |
| | resistivity of at least 10 Ω · m (measured according to |
| | ASTM D257, C611, or B193). |
| Thermally conductive, | A pigment, filler, or inorganic powder that has a |
| electrically conductive | thermal conductivity of at least 5 W/m · K at 25° C. |
| materials | (measured according to ASTM D7984) and a volume |
| | resistivity of less than 10 Ω · m (measured according |
| | to ASTM D257, C611, or B193). |
| Non-thermally conductive, | A pigment, filler, or inorganic powder that that has a |
| electrically insulative | thermal conductivity of less than 5 W/m · K at 25° C. |
| materials | (measured according to ASTM D7984) and a volume |
| | resistivity of at least 10 Ω · m (measured according to |
| | ASTM D257, C611, or B193). |

Any suitable combination of coreactive composition(s) and optionally additive(s)/filler(s), can be printed by a three-dimensional printing system adapted for mixing and extruding feedstocks. Two or more volumetric metering pumps (e.g., positive displacement pumps, progressive cavity pumps, etc.) may each respectively discharge, in combination or succession, the two coreactive components associated with a coreactive composition (e.g., the first reactive component discharged by the first metering pump and the second coreactive component discharged by the second metering pump into a mixing volume). In some cases, the mixing volume can include mechanical (e.g., driven) mixing features. Upon entering the mixing volume, the first and second coreactive components begin to mix and react, and thereafter, are extruded through an extrusion print nozzle in an at least partially reacted state. Once extruded, the two coreactive components further react and cure, which, as described above, may be under ambient conditions or using UV light to accelerate the ambient curing, to form either a thermoset, a thermoplastic material, or combinations thereof. The printable thermosetting coreactive composition may be exposed to UV light to accelerate the curing during printing, before printing, after printing, before any purge step, during the purge step, and/or after the purge step.

### III. Multi-Component Additive Manufacturing Device

Traditional 2-print head devices may only print one coreactive composition at a time. With some devices, a user may be required to replace or switch out print heads to print a 3D object made of multiple coreactive compositions. Alternatively, the user may even need multiple 2-print head devices to print a 3D object made of multiple printable compositions. The disclosed additive manufacturing device can print a variety of coreactive compositions, for example the coreactive compositions described above, simultaneously and/or sequentially to achieve an object with a variety of physical properties, such as texture, elasticity, hardness, and much more. The versatility of the disclosed additive manufacturing device has the benefit of increasing the speed of multi-composition printing due to the lack of need to switch print heads, reducing costs due to only one device being needed to print multiple compositions, and allowing the different printed compositions to be combined while in liquid form due to multiple printable compositions being printed in quick succession so they react and cure with one another at the boundary between compositions.

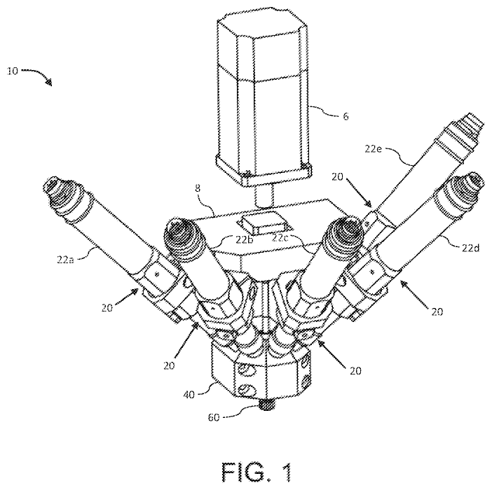

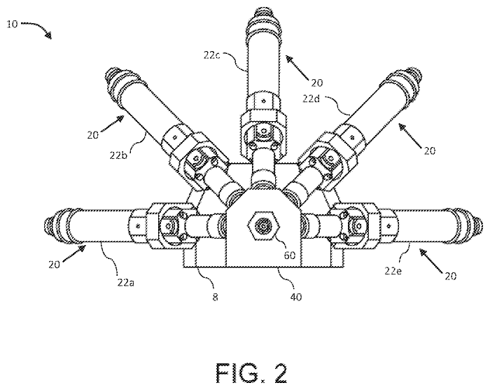

An additive manufacturing device 10 of the present application is designed to hold multiple pumping arrangements 20 that supply coreactive components used in additive manufacturing, as seen in FIGS. 1-3. The different coreactive components share a coreactive chemistry with each other. These coreactive components can be combined to form printable compositions. Each printable composition is made of a combination of at least two of the printable coreactive components. Additive manufacturing device 10 is configured to use any of the printable coreactive components discussed above to print any of the printable compositions described in section II.

Additive manufacturing device 10 of the present application may include at least three pumping arrangements 20, a mixing arrangement 30, and a print nozzle 60. Device 10 may include a top mount 8 that supports each of at least three pumping arrangements 20 and removably couples additive manufacturing device 10 to a 3D printer. Each of the at least three pumping arrangements 20 may be configured to dispense a coreactive component into mixing arrangement 30. Additionally, one of the at least three pumping arrangements 20 may include a flush media to dispense through additive manufacturing device 10 in between the printing of different printable compositions. Additive manufacturing device 10 is configured to dispense multiple coreactive components of the at least three pumping arrangements 20 into mixing arrangement 30. The printable coreactive components may be mixed in mixing arrangement 30 forming a printable composition. The printable composition may be extruded from mixing arrangement 30, through print nozzle 60. Print nozzle 60 may deposit the printable composition such that a 3D object is formed. Each of the components that comprise additive manufacturing device 10 and methods of printing are discussed in more detail below.

### A. Pumping Arrangements

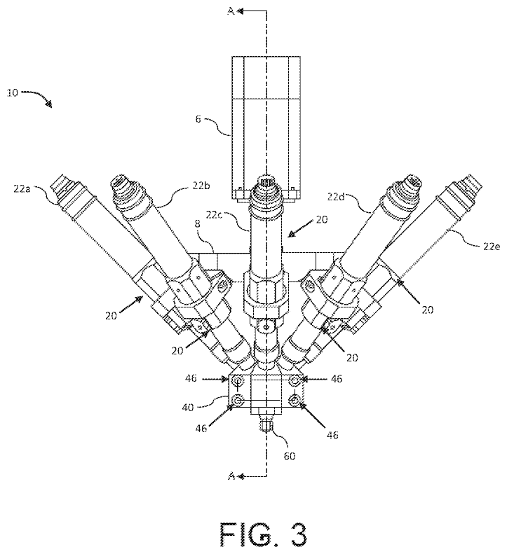

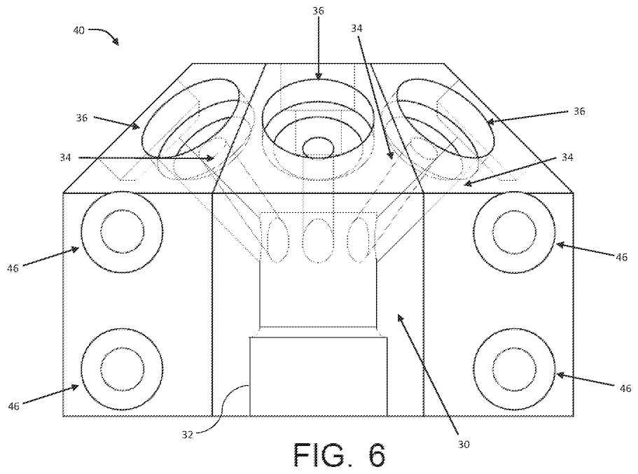

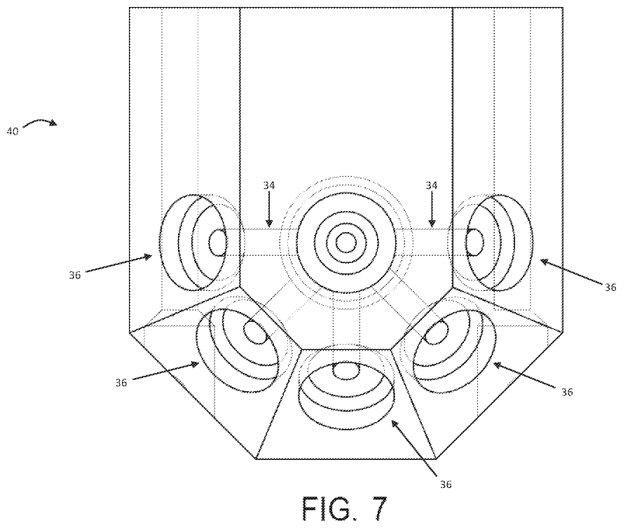

At least three pumping arrangements 20 can be removably coupled to a diamond mount 40 of additive manufacturing device 10 of the present disclosure. Each of the at least three pumping arrangements 20 is fluidly coupled with a source of a respective coreactive component. The respective coreactive component is discharged through a distal end of each of the at least three pumping arrangements 20 into a fluid channel 34. The fluid channel is discussed in greater detail below. As shown in FIGS. 6-7, diamond mount 40 comprises at least three orifices 36 that correspond and receive the distal end of the at least three pumping arrangements 20. Diamond mount 40 may be configured to connect the distal ends of the at least three pumping arrangements 20 with fluid channels 34 such that discharged coreactive components flow from the at least three pumping arrangements 20 into fluid channels 34. Mounting bores 46 may be arranged on diamond mount 40 such that diamond mount 40 is removable coupled to a mount to provide stability to additive manufacturing device 10. The at least three pumping arrangements 20 may be angled relative to axis A, as seen in FIG. 3. Between the support of top mount 8 and the support of diamond mount 40 of the at least three pumping arrangements 20, the at least three pumping arrangements are angled such that the distal end of each of the at least three pumping arrangements points toward axis A.

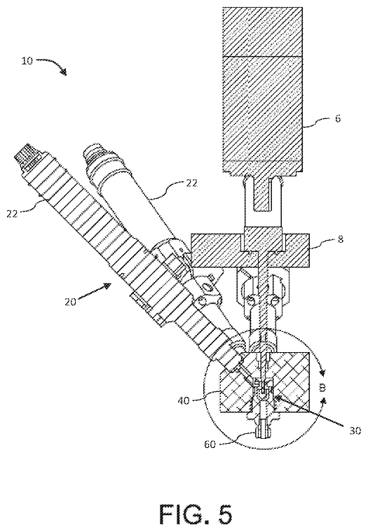

Referring to FIGS. 1-5, each of the at least three pumping arrangements 20 includes a positive displacement-type pump, such as progressive cavity pump 22. To prevent backflow, progressive cavity pumps 22 can be configured similar to a screw. Due to the design of progressive cavity pumps 22, as the printable coreactive component is discharged, the flow can only move in the direct of discharge. Additionally, progressive cavity pumps 22 can meter flow to a given volumetric dosage. Alternatively, any cartridge, pen, or other coreactive composition extruder may be used in pumping arrangement 20.

As seen in FIGS. 1-3, additive manufacturing device 10 may include, a first 22a, second 22b, third 22c, fourth 22d, and fifth 22e progressive cavity pump each containing a different coreactive component. While FIGS. 1-3 demonstrates a configuration of five progressive cavity pumps 22, it is understood that additive manufacturing device 10 may be adapted to include only four cavity pumps, or, alternatively, only three cavity pumps.

First progressive cavity pump 22a may discharge a first coreactive component in conjunction with second progressive cavity 22b pump that discharges a second coreactive component. Similarly, third progressive cavity pump 22c may discharge a third coreactive component in conjunction with fourth progressive cavity pump 22d that discharges a fourth coreactive component. Fifth progressive cavity pump 22e may discharge a fifth coreactive component in conjunction with at least one of the first, second, third, or fourth progressive cavity pumps 22a-d. Alternatively, any one of progressive cavity pumps 22 may comprise a flush media. To clean out the additive manufacturing device, the flush media may be discharged from progressive cavity pump 22 in between the printing of different printable compositions.

### B. Mixing Arrangement

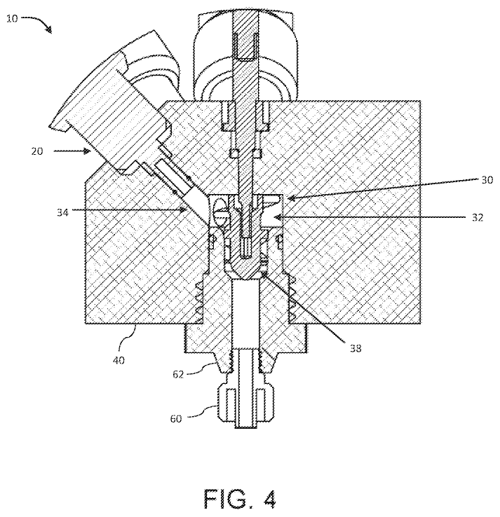

Referring to FIGS. 4-6, a mixing arrangement for additive manufacturing device 10 is provided. Located downstream of pumping arrangements 20 within diamond mount 40, mixing arrangement 30 may comprise a mixing volume 32, at least three fluid channels 34, and a mixer 38. The at least three fluid channels 34 fluidly connect each of progressive cavity pumps 22 to mixing volume 32. The configuration of the at least three fluid channels 34 may be adapted to any arrangement such that the discharged coreactive compositions flow through the at least three fluid channel 34 into mixing volume 32. Mixing volume 32 may be a cylindrical shape or any other geometry adapted for capturing discharged coreactive compositions. The geometry of mixing volume 32 may depend on the properties or volume of the discharged coreactive compositions, or available space within diamond mount 40.

Timing of the printable coreactive components reaching mixing volume 32 may affect the reaction between coreactive components. Residence timing refers to the time that elapses between one coreactive component entering mixing volume 32 and another coreactive component entering mixing volume 32 to be mixed into a printable composition. The residence timing between one coreactive composition and another may be less than 5 seconds. The progressive cavity pumps 22 containing the printable coreactive components included in a given printable composition dispense the printable coreactive components such that the printable coreactive components are present in mixing volume 32 simultaneously, or, at most, enter into mixing volume 32 from channels 34 within 5 seconds of each other. Once within mixing volume 32, coreactive components are mixed together to form a printable composition.

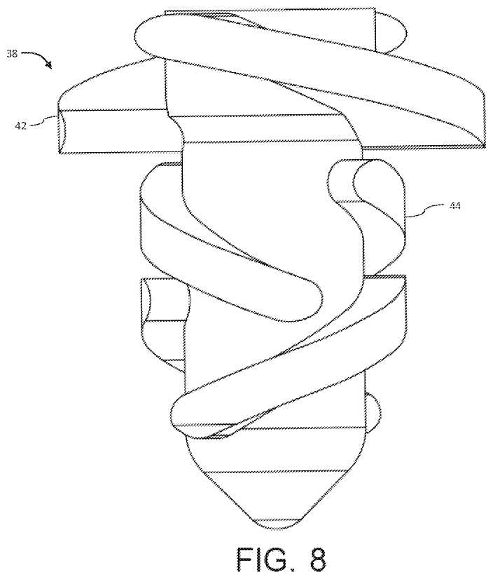

Within mixing volume 32 is a mixer 38, best seen in FIGS. 4 and 8, such as an impeller 42. Impeller 42 may be a screw-like element with threads 44 that dynamically or statically mix coreactive compositions as the compositions enter mixing volume 32. For dynamic mixing, impeller 42 may be connected to a motor 6 such that impeller 42 rotates within mixing volume 32.

The dynamic mixing of the coreactive composition by driven impeller 42 may have certain benefits over static mixing. Generally, mechanical mixing results in more thoroughly mixed coreactive compositions as compared with static mixing (e.g., by the driven nature of impeller 42). In this case, the size of mixing volume 32 may therefore be comparatively smaller than a mixing volume required for static mixing, decreasing the overall size of additive manufacturing device 10 (e.g., decreasing the size of mixing volume 32). This relatively smaller size of additive manufacturing device 10 results in more stable printing since the volume of retained material (e.g., the amount of material between pumping arrangement 20 and print nozzle 60) within additive manufacturing device 10 is lessened, increasing the granularity in pumping rate control.

Additionally, the rate of reaction between the printable coreactive components can be more easily controlled by a driven impeller 42. Specifically, the speed that impeller 42 is driven at (e.g., the resulting revolutions per minute (RPM) that the impeller 42 spins), can be adjusted to target an overall mixing rate. The RPM simultaneously influences the amount of material extruded from the print nozzle 60. Therefore, RPM can be tuned to simultaneously effect the extent of mixing and extrusion rate, both of which effect the extent and rate of reaction of the printable coreactive components.

Furthermore, driven impeller 42 and pumping arrangements 20 can be controlled independently from one another. Therefore, both RPM and pumping rate can be tuned independently, which in combination, may result in any one of a desired extent of reaction of the printable coreactive components, a targeted reaction rate of the printable coreactive components, a resonance time of material in in the mixing volume 32, and/or a extrusion rate of the coreactive composition from mixing volume 32.

Additive manufacturing device 10 may hold printable composition within the mixing volume for a period of time. The period of time may be from 0 seconds, 1 seconds, 2 seconds, 3 seconds, to 5 seconds, 6 seconds, 7 seconds, or within any range using any two of the foregoing as endpoints, such as 0-7 seconds, 1-6 seconds, 2-5 seconds, or 3-4 seconds. Holding the printable composition within the mixing volume may ensure that the printable coreactive components are fully mixed and a homogeneous printable composition is created.

### C. Print Nozzle

Printable compositions from mixing volume 32 are extruded out a print nozzle 60. Print nozzle 60 is removably coupled to a plug 62 that seals a distal end of mixing volume 32. Plug 62 ensures that the printable composition does not leak out of mixing volume 32. Print nozzle 60 may be a variety of shapes to facilitate the extrusion of printable compositions.

### D. Flush Media

Once a printable composition has been extruded from nozzle 60 to form a 3D object, the user may want to change the type of printable composition extruded from additive manufacturing device 60. In order to ensure that mixing arrangement 30 is free of previously printed printable composition, a flush media may be extruded by one of the at least three pumping arrangements 20. The flush media may be a commercially available non-reactive media configured to clear printable compositions from mixing arrangement 30. The flush media may be a flowable, non-reactive composition, such as, but not limited to, a hydrogel.

### IV. Printing Using the Additive Manufacturing Device

The present disclosure provides methods of printing using additive manufacturing device 10.

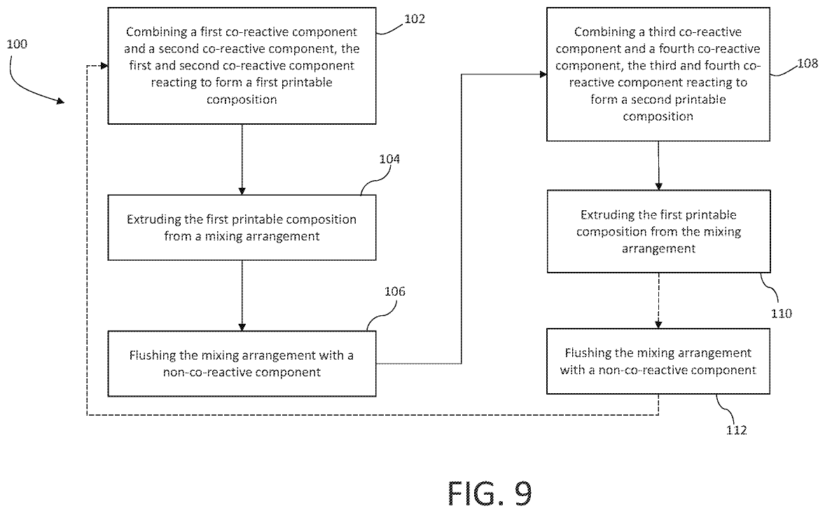

Referring to FIG. 9, a method of additive manufacturing is shown for printing a 3D object using the additive manufacturing device 10. Method 100 comprises a combining step 102, an extruding step 104, a flush step 106, a combining step 108, and an extruding step 110. In combining step 102, a first coreactive component and a second coreactive component are combined in a mixing arrangement. The printable coreactive components may be any of the coreactive components mentioned in section II above. Prior to combination, the first and second coreactive components may be held in corresponding pumping arrangements of an additive manufacturing device. To combine the first and second coreactive components, the components may be added to a mixing arrangement and mixed with an impeller. Once combined, the first and second coreactive components may react to form a first printable composition. The mixing parameters such as time spent mixing, mixing speed, mixing device, temperature, and/or pressure may vary depending on operating parameters or desired product parameters such as the amount and type of coreactive components used, the volume of components in the mixture, desired properties of the printable composition, desired properties of the printed object, and any combination of the foregoing. The first printable composition may be any of the printable compositions mentioned in section II above.

Extruding step 104 comprises extruding the first printable composition from the mixing arrangement through a print nozzle onto a printing surface to form a 3D object. The printing surface may be a printing bed or any other material. The speed of extruding the first printable composition from the mixing arrangement may vary depending on the properties of the printable composition.

To continue with printing a second printable composition, flushing step 106 comprises flushing the mixing arrangement with a non-coreactive component. The non-coreactive component may be any commercially available flush media. Flush media may be held in a pumping arrangement, similar to the first and second coreactive components. Flushing step 106 removes residual printable composition, or previous coreactive components from the mixing arrangement so that further printable compositions are not contaminated with previous coreactive components or printable compositions.

To accelerate curing, the printable coreactive composition may optionally be exposed to UV light during printing, before printing, after printing, before the purge step, during the purge step, and/or after the purge step.

In combining step 108, a third coreactive component and a fourth coreactive component are combined in a mixing arrangement. The printable coreactive components may be any of the printable coreactive components mentioned in section II above. Prior to combination, the third and fourth coreactive components may be held in corresponding pumping arrangements of an additive manufacturing device. To combine the third and fourth coreactive components, the components may be added to a mixing arrangement and mixed with an impeller. Once combined, the third and fourth coreactive components may react to form a second printable composition. Similar to the first printable composition, the mixing parameters may vary depending on the properties of the printable coreactive components and the second printable composition. The second printable composition may also be any of the printable compositions mentioned in section II above.

Extruding step 110 comprises extruding the second printable composition from the mixing arrangement, through a print nozzle, and onto the print surface. The speed of extruding the second printable composition from the mixing arrangement may vary depending on the properties of the printable composition. The second printable composition may be extruded onto the first printable composition that has already been deposited such that the first printable composition and second printable composition become one 3D printed object. The speed of which the second printable composition is deposited onto the first printable composition may be faster than the speed at which the first printable composition can fully cure. If the first printable composition is not fully cured, the first printable composition and the second printable composition may react at the boundary between the first printable composition and the second printable composition to create the one 3D printed object. Further, to accelerate curing, the second printable composition may be exposed to UV light during printing, before printing, after printing, before the purge step, during the purge step, and/or after the purge step.

To continue printing printable compositions, method 100 may optionally have a second flushing step 112. Flushing step 112 may comprise flushing the mixing arrangement with the flush media, similar to flushing step 106. Further, method 100 may be optionally repeated to fully complete a desired 3D printed object. A 3D objected printed using method 100 may include multiple printable compositions printed from the same additive manufacturing device in quick succession. By flushing the mixing arrangement in between printing different printable compositions, method 100 may print different printable compositions that are free from contaminants from each printable composition.

A 3D printed object created using method 100 may be made of multiple printable compositions. Due to the speed of printing multiple printable compositions using method 100, the final 3D printed object may be made of printable compositions that have reacted with each other and formed one multi-printable composition 3D object.

The present disclosure provides a second method of printing using additive manufacturing device 10.

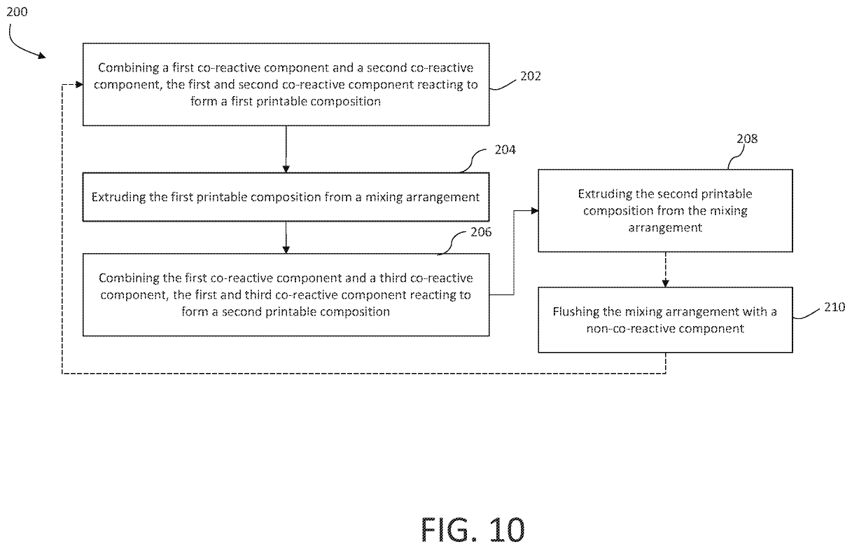

Referring to FIG. 10, a method of additive manufacturing is shown for printing a 3D object using the additive manufacturing device 10. Method 200 comprises a combining step 202, an extruding step 204, a combining step 206, and an extruding step 208. In combining step 202, a first coreactive component and a second coreactive component are combined in a mixing arrangement. The printable coreactive components may be any of the printable coreactive components mentioned in section II above. Prior to combination, the first and second coreactive components may be held in corresponding pumping arrangements of an additive manufacturing device. To combine the first and second coreactive components, the components may be added to a mixing arrangement and mixed with an impeller. Once combined, the first and second coreactive components may react to form a first printable composition. The mixing parameters such as time spent mixing, mixing speed, mixing device, temperature, and/or pressure may vary depending on operating parameters or desired product parameters such as the amount and type of coreactive components used, the volume of components in the mixture, desired properties of the printable composition, desired properties of the printed object, and any combination of the foregoing. The first printable composition may be any of the printable compositions mentioned in section II above.

Extruding step 204 comprises extruding the first printable composition from the mixing arrangement, through a print nozzle, onto a printing surface to form a 3D object. The printing surface may be a printing bed or any other material. The speed of extruding the first printable composition from the mixing arrangement may vary depending on the properties of the printable composition.

In combining step 206, a third coreactive component is combined with the first coreactive component in the mixing arrangement. The printable coreactive components may be any of the printable coreactive components mentioned in section II above. Prior to combination, the third coreactive component may be held in a pumping arrangements of an additive manufacturing device. Each of the pumping arrangements of the additive manufacturing device may contain a coreactive component. The first coreactive component may react with each of the other coreactive components to form different printable compositions. That is to say, each coreactive component reacts with the first coreactive component to form a respective printable composition. There may be a first, second, third, fourth, and fifth coreactive component held in a corresponding pumping arrangement.

Referring back to step 206, to combine the first and third coreactive components, the components may be added to a mixing arrangement and mixed with an impeller. Once combined, the first and third coreactive components may react to form a second printable composition. Similar to the first printable composition, the mixing parameters may vary depending on the properties of the printable coreactive components and the second printable composition. The second printable composition may also be any of the printable compositions mentioned in section II above.

Extruding step 208 comprises extruding the second printable composition from the mixing arrangement through a print nozzle onto a printing surface to form a 3D object. The printing surface may be a printing bed or any other material. The speed of extruding the first printable composition from the mixing arrangement may vary depending on the properties of the printable composition.

The second printable composition may be extruded onto the first printable composition that has already been deposited such that the first printable composition and second printable composition become one 3D printed object. The speed of which the second printable composition is deposited onto the first printable composition may be faster than the first printable composition can fully cure. If the first printable composition is not fully cured, the first printable composition and the second printable composition may react at the boundary between the first printable composition and the second printable composition to create the one 3D printed object.

Method 200 may optionally include a flushing step 210 that comprises flushing the mixing arrangement with a non-coreactive component. The non-coreactive component may be a flush media previously described. Flushing step 210 may remove any residual printable composition, or previously used coreactive components from the mixing arrangement so that further printable compositions are not contaminated with previous coreactive components or printable compositions. Step 210 is not required but may be included if desired. Additionally, method 200 may optionally be repeated to form a multi-printable-composition 3D object.

### EXAMPLES

Aspects of the present disclosure are further illustrated by reference to the following examples. It will be apparent to those skilled in the art that many modifications, both to materials, and methods, may be practiced without departing from the scope of the disclosure.

### Example 1-In-Line Compositional Changes with ARE 3D-Printing

Each of the five print head pumps are loaded with distinct formulations to allow for two unique thermoset compositions to be printed into a single 3D-printed part, as seen in Table 3. To print the first composition, pump 1 is loaded with a first amine formulation (Formulation A) and pump 2 is loaded with a first isocyanate formulation (Formulation C). The first segment of the part is printed by metering formulations from pumps 1 and 2 in a fixed volumetric ratio through a mixer to produce a first thermosetting composition. The first composition is deposited on the print bed in a predefined toolpath until the part segment is completed. The print head is then moved to a defined purge location. A purge compound, loaded in pump 3, is then metered through the mixer to remove all the first composition from the print head. Once purging is complete, the print head returns to an area on the print bed where the second segment of the part can be printed. The second segment is printed by metering a second amine formulation (Formulation B) from pump 4 and a second isocyanate formulation (Formulation D) from pump 5 in a fixed volumetric ratio through a mixer to produce a second thermosetting composition. The second composition is deposited on the print bed in a predefined toolpath as to complete the final part in conjunction with the first segment. Each individual printing step occurs under ambient conditions, whereas the final multi-composition part is allowed to cure at 71° C. for 48 hours.

TABLE 3
Multi-Pump Loading According to Example 1

| Formu- | | | | | |
|---|---|---|---|---|---|
| lation | Pump 1 | Pump 2 | Pump 3 | Pump 4 | Pump 5 |
| 1 | Amine | Isocyanate | Purge | Amine | Isocyanate |
| | Formu- | Formu- | | Formu- | Formu- |
| | lation A | lation C | | lation B | lation D |

Table 4 exemplifies a various combinations of different printable compositions (e.g., formulations 2-45) that can be loaded into the five print head pumps and thereafter printed according to the scheme described in relation to Example 1.

TABLE 4
Examples of Multi-Pump Loading According to Example 1

| Formu- | | | | | |
|---|---|---|---|---|---|
| lation | Pump 1 | Pump 2 | Pump 3 | Pump 4 | Pump 5 |
| 2 | Amine | Isocyanate | Purge | Acrylate | Amine |
| | Formu- | Formu- | | Formu- | Formu- |
| | lation A | lation C | | lation B | lation D |
| 3 | Amine | Isocyanate | Purge | Isocyanate | Polyol |
| | Formu- | Formu- | | Formu- | Formu- |
| | lation A | lation C | | lation B | lation D |
| 4 | Amine | Isocyanate | Purge | Epoxy | Amine |
| | Formu- | Formu- | | Formu- | Formu- |
| | lation A | lation C | | lation B | lation D |
| 5 | Amine | Isocyanate | Purge | Epoxy | Thiol |
| | Formu- | Formu- | | Formu- | Formu- |
| | lation A | lation C | | lation B | lation D |
| 6 | Amine | Isocyanate | Purge | Aceto- | Amine |
| | Formu- | Formu- | | acetate | Formu- |
| | lation A | lation C | | Formu- | lation D |
| | | | | lation | |
| 7 | Amine | Isocyanate | Purge | Acetoxy-, | Silanol- |
| | Formu- | Formu- | | alkoxy-, | containing |
| | lation A | lation C | | oxime-, or | Silicone |
| | | | | acetone- | Formu- |
| | | | | Containing | lation |
| | | | | Silicone | |
| | | | | Compounds | |
| | | | | Formu- | |
| | | | | lation | |
| 8 | Amine | Isocyanate | Purge | Thiol | Catalyst |
| | Formu- | Formu- | | Formu- | and/or |
| | lation A | lation C | | lation | Activator |
| | | | | | Formu- |
| | | | | | lation |
| 9 | Amine | Isocyanate | Purge | Hydride- | Vinyl- |
| | Formu- | Formu- | | functional | functional |
| | lation A | lation C | | Silicone | Silicone |
| | | | | Formu- | Formu- |
| | | | | lation | lation |
| 10 | Acrylate | Amine | Purge | Acrylate | Amine |
| | Formu- | Formu- | | Formu- | Formu- |
| | lation A | lation C | | lation B | lation D |
| 11 | Acrylate | Amine | Purge | Isocyanate | Polyol |
| | Formu- | Formu- | | Formu- | Formu- |
| | lation | lation | | lation | lation |
| 12 | Acrylate | Amine | Purge | Epoxy | Amine |
| 13 | Acrylate | Amine | Purge | Epoxy | Thiol |
| 14 | Acrylate | Amine | Purge | Aceto- | Amine |
| | | | | acetate | |
| 15 | Acrylate | Amine | Purge | Acetoxy-, | Silanol- |
| | | | | alkoxy-, | containing |
| | | | | oxime-, or | Silicone |
| | | | | acetone- | |
| | | | | containing | |
| | | | | silicone | |
| | | | | compounds | |
| 16 | Acrylate | Amine | Purge | Thiol | Catalyst |
| | | | | | and/or |
| | | | | | Activator |
| 17 | Acrylate | Amine | Purge | Hydride- | Vinyl- |
| | | | | functional | functional |
| | | | | Silicone | Silicone |
| 18 | Isocyanate | Polyol | Purge | Isocyanate | Polyol |
| 19 | Isocyanate | Polyol | Purge | Epoxy | Amine |
| 20 | Isocyanate | Polyol | Purge | Epoxy | Thiol |
| 21 | Isocyanate | Polyol | Purge | Aceto- | Amine |
| | | | | acetate | |
| 22 | Isocyanate | Polyol | Purge | Acetoxy-, | Silanol- |
| | | | | alkoxy-, | containing |
| | | | | oxime-, or | Silicone |
| | | | | acetone- | |
| | | | | containing | |
| | | | | silicone | |
| | | | | compounds | |
| 23 | Isocyanate | Polyol | Purge | Thiol | Catalyst |
| | | | | | and/or |
| | | | | | Activator |
| 24 | Isocyanate | Polyol | Purge | Hydride- | Vinyl- |
| | | | | functional | functional |
| | | | | Silicone | Silicone |
| 25 | Epoxy | Amine | Purge | Epoxy | amine |
| 26 | Epoxy | Amine | Purge | Epoxy | Thiol |
| 27 | Epoxy | Amine | Purge | Aceto- | Amine |
| | | | | acetate | |
| 28 | Epoxy | Amine | Purge | Acetoxy-, | Silanol- |
| | | | | alkoxy-, | containing |
| | | | | oxime-, or | Silicone |
| | | | | acetone- | |
| | | | | containing | |
| | | | | silicone | |
| | | | | compounds | |
| 29 | Epoxy | Amine | Purge | Thiol | Catalyst |
| | | | | | and/or |
| | | | | | Activator |
| 30 | Epoxy | Amine | Purge | Hydride- | Vinyl- |
| | | | | functional | functional |
| | | | | Silicone | Silicone |
| 31 | Epoxy | Thiol | Purge | Epoxy | Thiol |
| 32 | Epoxy | Thiol | Purge | Aceto- | Amine |
| | | | | acetate | |
| 33 | Epoxy | Thiol | Purge | Acetoxy-, | Silanol- |
| | | | | alkoxy-, | containing |
| | | | | oxime-, or | Silicone |
| | | | | acetone- | |
| | | | | containing | |
| | | | | silicone | |
| | | | | compounds | |
| 34 | Epoxy | Thiol | Purge | Thiol | Catalyst |
| | | | | | and/or |
| | | | | | Activator |
| 35 | Epoxy | Thiol | Purge | Hydride- | Vinyl- |
| | | | | functional | functional |
| | | | | Silicone | Silicone |
| 36 | Aceto- | Amine | Purge | Aceto- | Amine |
| | acetate | | | acetate | |
| 37 | Aceto- | Amine | Purge | Acetoxy-, | Silanol- |
| | acetate | | | alkoxy-, | containing |
| | | | | oxime-, or | Silicone |
| | | | | acetone- | |
| | | | | containing | |
| | | | | silicone | |
| | | | | compounds | |
| 38 | Aceto- | Amine | Purge | Thiol | Catalyst |
| | acetate | | | | and/or |
| | | | | | Activator |
| 39 | Aceto- | Amine | Purge | Hydride- | Vinyl- |
| | acetate | | | functional | functional |
| | | | | Silicone | Silicone |
| 40 | Acetoxy-, | Silanol- | Purge | Acetoxy-, | Silanol- |
| | alkoxy-, | containing | | alkoxy-, | containing |
| | oxime-, or | Silicone | | oxime-, or | Silicone |
| | acetone- | | | acetone- | |
| | containing | | | containing | |
| | silicone | | | silicone | |
| | compounds | | | compounds | |
| 41 | Acetoxy-, | Silanol- | Purge | Thiol | Catalyst |
| | alkoxy-, | containing | | | and/or |
| | oxime-, or | Silicone | | | Activator |
| | acetone- | | | | |
| | containing | | | | |
| | silicone | | | | |
| | compounds | | | | |
| 42 | Acetoxy-, | Silanol- | Purge | Hydride- | Vinyl- |
| | alkoxy-, | containing | | functional | functional |
| | oxime-, or | Silicone | | Silicone | Silicone |
| | acetone- | | | | |
| | containing | | | | |
| | silicone | | | | |
| | compounds | | | | |
| 43 | Thiol | Catalyst | Purge | Thiol | Catalyst |
| | | and/or | | | and/or |
| | | Activator | | | Activator |
| 44 | Thiol | Catalyst | Purge | Hydride- | Vinyl- |
| | | and/or | | functional | functional |
| | | Activator | | Silicone | Silicone |
| 45 | Hydride- | Vinyl- | Purge | Hydride- | Vinyl- |
| | functional | functional | | functional | functional |
| | Silicone | Silicone | | Silicone | Silicone |

### Example 2-On-Demand Material Property Modulation with ARE 3D-Printing

Each of the five print head pumps are loaded with distinct formulations to allow for on-demand modulation of material properties in a 3D-printed part, as seen in Table 5. Pump 1 is loaded with isocyanate formulation E, and pumps 2-5 are loaded with amine formulations A-D, respectively. At the start of the print, the first segment is printed by metering formulations A-D with respect to formulation E through a mixer in a defined volumetric ratio to produce a first thermosetting composition with known material properties. At the conclusion of the first segment, a second segment is printed by varying the ratio at which formulations A-D are metered with respect to formulation E; thereby creating a second thermosetting composition with distinct material properties from the first thermosetting composition. This process is repeated two more times to create third and fourth thermosetting compositions for third and fourth segments of the printed part. This resulted in a single 3D-printed part with four segments, each having distinct material properties. Each individual printing step occurs under ambient conditions, whereas the final multi-composition part is allowed to cure at 71° C. for 48 hours.

TABLE 5
Multi-Pump Loading According to Example 2

| Formu- | | | | | |
|---|---|---|---|---|---|
| lation | Pump 1 | Pump 2 | Pump 3 | Pump 4 | Pump 5 |
| 46 | Isocyanate | Amine | Amine | Amine | Amine |
| | Formu- | Formu- | Formu- | Formu- | Formu- |
| | lation E | lation A | lation B | lation C | lation D |

Table 6 shows various combinations of different printable compositions (e.g., formulations 47-65) that can be loaded into the five print head pumps and thereafter printed according to the scheme described in relation to Example 2.

TABLE 6
Examples of Multi-Pump Loading According to Example 2

| Formu- | | | | | |
|---|---|---|---|---|---|
| lation | Pump 1 | Pump 2 | Pump 3 | Pump 4 | Pump 5 |
| 47 | Amine | Isocyanate | Isocyanate | Isocyanate | Isocyanate |
| | | Formu- | Formu- | Formu- | Formu- |
| | | lation A | lation B | lation C | lation D |
| 48 | Isocyanate | Polyol | Polyol | Polyol | Polyol |
| | | Formu- | Formu- | Formu- | Formu- |
| | | lation A | lation B | lation D | lation D |
| 49 | Polyol | Isocyanate | Isocyanate | Isocyanate | Isocyanate |
| | | Formu- | Formu- | Formu- | Formu- |
| | | lation A | lation B | lation C | lation D |
| 50 | Acrylate | Amine | Amine | Amine | Amine |
| | (Michael | (Michael | (Michael | (Michael | (Michael |
| | Acceptor) | Donor) | Donor) | Donor) | Donor) |
| | | Formu- | Formu- | Formu- | Formu- |
| | | lation A | lation B | lation C | lation D |
| 51 | Amine | Acrylate | Acrylate | Acrylate | Acrylate |
| | (Michael | (Michael | (Michacl | (Michael | (Michael |
| | Donor) | Acceptor) | Acceptor) | Acceptor) | Acceptor) |
| | | Formu- | Formu- | Formu- | Formu- |
| | | lation A | lation B | lation C | lation D |
| 52 | Epoxy | Amine | Amine | Amine | Amine |
| | | Formu- | Formu- | Formu- | Formu- |
| | | lation A | lation B | lation C | lation D |
| 53 | Amine | Epoxy | Epoxy | Epoxy | Epoxy |
| | | Formu- | Formu- | Formu- | Formu- |
| | | lation A | lation B | lation C | lation D |
| 54 | Epoxy | Thiol | Thiol | Thiol | Thiol |
| | | Formu- | Formu- | Formu- | Formu- |
| | | lation A | lation B | lation C | lation D |
| 55 | Thiol | Epoxy | Epoxy | Epoxy | Epoxy |
| | | Formu- | Formu- | Formu- | Formu- |
| | | lation A | lation B | lation C | lation D |
| 56 | Aceto- | Amine | Amine | Amine | Amine |
| | acetate | Formu- | Formu- | Formu- | Formu- |
| | | lation A | lation B | lation C | lation D |
| 57 | Amine | Aceto- | Aceto- | Aceto- | Aceto- |
| | | acetate | acetate | acetate | acetate |
| | | Formu- | Formu- | Formu- | Formu- |
| | | lation A | lation B | lation C | lation D |
| 58 | Amine | Isocyanate | Epoxy | Acrylate | Aceto- |
| | | | | (Michael | acetate |
| | | | | Acceptor) | |
| 59 | Thiol | Isocyanate | Epoxy | Acrylate | Aceto- |
| | | | | (Michael | acetate |
| | | | | Acceptor) | |
| 60 | Hydride- | Vinyl- | Vinyl- | Vinyl- | Vinyl- |
| | functional | functional | functional | functional | functional |
| | silicone | Silicone | Silicone | Silicone | Silicone |
| | | Formu- | Formu- | Formu- | Formu- |
| | | lation A | lation B | lation C | lation D |
| 61 | Vinyl- | Hydride- | Hydride- | Hydride- | Hydride- |
| | functional | functional | functional | functional | functional |
| | silicone | Silicone | Silicone | Silicone | Silicone |
| | | Formu- | Formu- | Formu- | Formu- |
| | | lation A | lation B | lation C | lation D |
| 62 | Silanol- | Formu- | Formu- | Formu- | Formu- |
| | containing | lation A | lation B | lation C | lation D |
| | Silicone | containing | containing | containing | containing |
| | | acetoxy-, | acetoxy-, | acetoxy-, | acetoxy-, |
| | | alkoxy-, | alkoxy-, | alkoxy-, | alkoxy-, |
| | | oxime, or | oxime, or | oxime, or | oxime, or |
| | | actone- | actone- | actone- | actone- |
| | | containing | containing | containing | containing |
| | | compounds | compounds | compounds | compounds |
| 63 | Acetoxy-, | Silanol- | Silanol- | Silanol- | Silanol- |
| | alkoxy-, | containing | containing | containing | containing |
| | oxime-, or | Silicone | Silicone | Silicone | Silicone |
| | acetone- | Formu- | Formu- | Formu- | Formu- |
| | containing | lation A | lation B | lation C | lation D |
| | silicone | | | | |
| | compounds | | | | |
| 64 | Catalyst | Thiol | Thiol | Thiol | Thiol |
| | and/or | Formu- | Formu- | Formu- | Formu- |
| | activator | lation A | lation B | lation C | lation D |
| | Formu- | | | | |
| | lation | | | | |
| 65 | Thiol | Catalyst/ | Catalyst/ | Catalyst/ | Catalyst/ |
| | | Activator | Activator | Activator | Activator |
| | | Formu- | Formu- | Formu- | Formu- |
| | | lation A | lation 2 | lation C | lation D |

### Example 3-ARE 3D-Printing with Multi-Component Additive Manufacturing Device

In this example, each of the five print head pumps is loaded with distinct formulations to allow for on-demand modulation of material properties in a 3D-printed part, as seen in Table 7. The printable coreactive components are combined in different configurations to make a printable composition comprising one printable coreactive chemistry. However, the physical properties of the printable composition are varied according to the formulation of the printable coreactive component in each pump that is used. For example, during a first print, isocyanate formulation A and amine formulation C are mixed to produce a first polyurea thermosetting composition with a first set of properties. However, during a second print, isocyanate formulation B and amine formulation D are mixed to produce a second polyurea thermosetting composition with a second set of properties. Further still, during a third print, isocyanate formulation A and amine formulation E are mixed to produce a third polyurea thermosetting composition with a third set of properties. The first, second, and third set of properties may vary in tensile strength, elasticity, flexibility, and other desirable physical properties of the printable composition based on the formulation of each printable coreactive component. Each individual printing step occurs under ambient conditions, whereas the final multi-composition part is allowed to cure at 71° C. for 48 hours.

TABLE 7
Examples of Multi-Pump Loading According to Example 3

| Formu- | | | | | |
|---|---|---|---|---|---|
| lation | Pump 1 | Pump 2 | Pump 3 | Pump 4 | Pump 5 |
| 66 | Isocyanate | Isocyanate | Amine | Amine | Amine |
| | Formu- | Formu- | Formu- | Formu- | Formu- |
| | lation A | lation B | lation C | lation D | lation E |

Table 8 shows various combinations of different printable compositions (e.g., formulations 67-83) that can be loaded into the five print head pumps and thereafter printed according to the scheme described in relation to Example 3.

TABLE 8
Examples of Multi-Pump Loading According to Example 3

| Formu- | | | | | |
|---|---|---|---|---|---|
| lation | Pump 1 | Pump 2 | Pump 3 | Pump 4 | Pump 5 |
| 67 | Isocyanate | Isocyanate | Isocyanate | Amine | Amine |
| | Formu- | Formu- | Formu- | Formu- | Formu- |
| | lation A | lation B | lation C | lation D | lation E |
| 68 | Isocyanate | Isocyanate | Polyol | Polyol | Polyol |
| | Formu- | Formu- | Formu- | Formu- | Formu- |
| | lation A | lation B | lation C | lation D | lation E |
| 69 | Isocyanate | Isocyanate | Isocyanate | Polyol | Polyol |
| | Formu- | Formu- | Formu- | Formu- | Formu- |
| | lation A | lation B | lation C | lation D | lation E |
| 70 | Acrylate | Acrylate | Amine | Amine | Amine |
| | (Michael | (Michael | Formu- | Formu- | Formu- |
| | acceptor) | acceptor) | lation C | lation D | lation E |
| | Formu- | Formu- | | | |
| | lation A | lation B | | | |
| 71 | Acrylate | Acrylate | Acrylate | Amine | Amine |
| | (Michael | (Michael | (Michael | Formu- | Formu- |
| | acceptor) | acceptor) | acceptor) | lation D | lation E |
| | Formu- | Formu- | Formu- | | |
| | lation A | lation B | lation C | | |
| 72 | Epoxy | Epoxy | Amine | Amine | Amine |
| | Formu- | Formu- | Formu- | Formu- | Formu- |
| | lation A | lation B | lation C | lation D | lation E |
| 73 | Epoxy | Epoxy | Epoxy | Amine | Amine |
| | Formu- | Formu- | Formu- | Formu- | Formu- |
| | lation A | lation B | lation C | lation D | lation E |
| 74 | Epoxy | Epoxy | Thiol | Thiol | Thiol |
| | Formu- | Formu- | Formu- | Formu- | Formu- |
| | lation A | lation B | lation C | lation D | lation E |
| 75 | Epoxy | Epoxy | Epoxy | Thiol | Thiol |
| | Formu- | Formu- | Formu- | Formu- | Formu- |
| | lation A | lation B | lation C | lation D | lation E |
| 76 | Aceto- | Aceto- | Amine | Amine | Amine |
| | acetate | acetate | Formu- | Formu- | Formu- |
| | Formu- | Formu- | lation C | lation D | lation E |
| | lation A | lation B | | | |
| 77 | Aceto- | Aceto- | Aceto- | Amine | Amine |
| | acetate | acetate | acetate | Formu- | Formu- |
| | Formu- | Formu- | Formu- | lation D | lation E |
| | lation A | lation B | lation C | | |
| 78 | Hydride- | Hydride- | Vinyl- | Vinyl- | Vinyl- |
| | functional | functional | functional | functional | functional |
| | Silicone | Silicone | Silicone | Silicone | Silicone |
| | Formu- | Formu- | Formu- | Formu- | Formu- |
| | lation A | lation B | lation C | lation D | lation E |
| 79 | Hydride- | Hydride- | Hydride- | Vinyl- | Vinyl- |
| | functional | functional | functional | functional | functional |
| | Silicone | Silicone | Silicone | Silicone | Silicone |
| | Formu- | Formu- | Formu- | Formu- | Formu- |
| | lation A | lation B | lation C | lation D | lation E |
| 80 | Acetoxy-, | Acetoxy-, | Silanol- | Silanol- | Silanol- |
| | alkoxy-, | alkoxy-, | containing | containing | containing |
| | oxime-, or | oxime-, or | Silicone | Silicone | Silicone |
| | acetone- | acetone- | Formu- | Formu- | Formu- |
| | containing | containing | lation C | lation D | lation E |
| | silicone | silicone | | | |
| | compounds | compounds | | | |
| | Formu- | Formu- | | | |
| | lation A | lation B | | | |
| 81 | Acetoxy-, | Acetoxy-, | Acetoxy-, | Silanol- | Silanol- |
| | alkoxy-, | alkoxy-, | alkoxy-, | containing | containing |
| | oxime-, or | oxime-, or | oxime-, or | Silicone | Silicone |
| | acetone- | acetone- | acetone- | Formu- | Formu- |
| | containing | containing | containing | lation D | lation E |
| | silicone | silicone | silicone | | |
| | compounds | compounds | compounds | | |
| | Formu- | Formu- | Formu- | | |
| | lation A | lation B | lation C | | |
| 82 | Catalyst | Catalyst | Thiol | Thiol | Thiol |
| | and/or | and/or | Formu- | Formu- | Formu- |
| | activator | activator | lation C | lation D | lation E |
| | Formu- | Formu- | | | |
| | lation A | lation B | | | |
| 83 | Catalyst | Catalyst | Catalyst | Thiol | Thiol |
| | and/or | and/or | and/or | Formu- | Formu- |
| | activator | activator | activator | lation D | lation E |
| | Formu- | Formu- | Formu- | | |
| | lation A | lation B | lation C | | |

### Example 4—UV Curable 3D-Printing with Multi-Component Additive Manufacturing Device

Each of the five print head pumps are loaded with distinct formulations to allow for two unique printable thermoset compositions to be printed into a single 3D-printed part, as seen in Table 9. To print the first printable thermoset composition, pump 1 is loaded with a first vinyl (or allyl) ether formulation (Formulation A) and pump 2 is loaded with a first thiol formulation (Formulation B). The first segment of the part is printed by metering formulations from pumps 1 and 2 in a fixed volumetric ratio through a mixer to produce a first thermosetting composition. The first composition is deposited on the print bed in a predefined toolpath until the part segment is completed. Shortly after extrusion of the mixed 2 component material, the material is exposed to ultraviolet wavelengths of light (395 nm) which cures the extruded polymer matrix within seconds. The print head is then moved to a defined purge location. A purge compound, loaded in pump 3, is then metered through the mixer to remove all the first composition from the print head. Once purging is complete, the print head returns to an area on the print bed where the second segment of the part will be printed. The second segment is printed by metering a second vinyl (or allyl) formulation (Formulation C) from pump 4 and a second thiol formulation (Formulation D) from pump 5 in a fixed volumetric ratio through a mixer to produce a second printable thermosetting composition. The second composition is deposited on the print bed in a predefined toolpath as to complete the final part in conjunction with the first segment. Shortly after extrusion of the mixed 2 component material, the material is exposed to ultraviolet wavelengths of light which cures the extruded polymer matrix within seconds. The final multi-composition part is then subjected to additional ultraviolet radiation (5-30 minutes) to ensure full cure of the polymer matrix throughout the part. Each individual printing step occurs under ambient conditions, whereas the final multi-composition part is allowed to cure at 71° C. for 48 hours.

TABLE 9
Prophetic Examples of Multi-Pump
Loading According to Example 4

| Formu- | | | | | |
|---|---|---|---|---|---|
| lation | Pump 1 | Pump 2 | Pump 3 | Pump 4 | Pump 5 |
| 84 | Vinyl Ether | Thiol | Purge | Vinyl Ether | Thiol |
| | (or | Formu- | | (or | Formu- |
| | allyl ether) | lation B | | allyl ether) | lation D |
| | Formu- | | | Formu- | |
| | lation A | | | lation C | |

Table 10 shows various combinations of different printable compositions (e.g., formulations 85-96) that can be loaded into the five print head pumps and thereafter printed according to the scheme described in relation to Example 4.

TABLE 10
Prophetic Examples of Multi-Pump Loading According to Example 4

| Formu- | | | | | |
|---|---|---|---|---|---|
| lation | Pump 1 | Pump 2 | Pump 3 | Pump 4 | Pump 5 |
| 85 | Vinyl Ether | Thiol | Thiol | Thiol | Thiol |
| | (or | Formu- | Formu- | Formu- | Formu- |
| | allyl ether) | lation B | lation C | lation D | lation E |
| | Formu- | | | | |
| | lation A | | | | |
| 86 | Thiol | Vinyl Ether | Vinyl Ether | Vinyl Ether | Vinyl Ether |
| | Formu- | (or | (or | (or | (or |
| | lation A | allyl Ether) | allyl Ether) | allyl Ether) | allyl Ether) |
| | | Formu- | Formu- | Formu- | Formu- |
| | | lation B | lation C | lation D | lation E |
| 87 | Vinyl Ether | Thiol | Purge | Isocyanate | Amine |
| | (or | Formu- | | Formu- | Formu- |
| | allyl ether) | lation B | | lation C | lation D |
| | Formu- | | | | |
| | lation A | | | | |
| 88 | Vinyl Ether | Thiol | Purge | Acrylate | Amine |
| | (or | Formu- | | Formu- | Formu- |
| | allyl ether) | lation B | | lation C | lation D |
| | Formu- | | | | |
| | lation A | | | | |
| 89 | Vinyl Ether | Thiol | Purge | Isocyanate | Polyol |
| | (or | Formu- | | Formu- | Formu- |
| | allyl ether) | lation B | | lation C | lation D |
| | Formu- | | | | |
| | lation A | | | | |
| 90 | Vinyl Ether | Thiol | Purge | Epoxy | Amine |
| | (or | Formu- | | Formu- | Formu- |
| | allyl ether) | lation B | | lation C | lation D |
| | Formu- | | | | |
| | lation A | | | | |
| 91 | Vinyl Ether | Thiol | Purge | Epoxy | Thiol |
| | (or | Formu- | | Formu- | Formu- |
| | allyl ether) | lation B | | lation C | lation D |
| | Formu- | | | | |
| | lation A | | | | |
| 92 | Vinyl Ether | Thiol | Purge | Epoxy | Amine |
| | (orallyl ether) | Formu- | | Formu- | Formu- |
| | Formu- | lation B | | lation C | lation D |
| | lation A | | | | |
| 93 | Vinyl Ether | Thiol | Purge | Acetoxy-, | Silanol- |
| | (or | Formu- | | alkoxy-, | containing |
| | allyl ether) | lation B | | oxime-, or | Silicone |
| | Formu- | | | acetone- | Formu- |
| | lation A | | | containing | lation D |
| | | | | silicone | |
| | | | | compounds | |
| | | | | Formu- | |
| | | | | lation C | |
| 94 | Vinyl Ether | Thiol | Purge | Thiol | Catalyst |
| | (or | Formu- | | Formu- | and/or |
| | allyl ether) | lation B | | lation D | Activator |
| | Formu- | | | | Formu- |
| | lation A | | | | lation D |
| 95 | Vinyl Ether | Thiol | Purge | Hydride- | Vinyl- |
| | (or | Formu- | | functional | functional |
| | allyl ether) | lation B | | Silicone | Silicone |
| | Formu- | | | Formu- | Formu- |
| | lation A | | | lation C | lation D |
| 96 | Vinyl Ether | Vinyl Ether | Thiol | Thiol | Thiol |
| | (or | (or | Formu- | Formu- | Formu- |
| | allyl ether) | allyl ether) | lation C | lation D | lation E |
| | Formu- | Formu- | | | |
| | lation A | lation B | | | |

1. An additive manufacturing device comprising:
at least three pumping arrangements, each of the at least three pumping arrangements configured to dispense a respective printable component;
a mixing arrangement fluidly coupled to each of the at least three pumping arrangements, the mixing arrangement comprising:
a mixing volume;
at least three fluid channels, wherein each one of the at least three fluid channels is fluidly coupled with one of the at least three pumping arrangements, and the respective printable component dispensed by each of the at least three pumping arrangements flows into the mixing volume through the fluid channel fluidly coupled to the pumping arrangement; and
a mechanical mixer positioned within the mixing volume, the mixer configured to mechanically mix the printable components dispensed from the at least three pumping arrangements; and
a print nozzle fluidly coupled to the mixing arrangement, the print nozzle configured to extrude the printable components during an additive manufacturing process.

2. The additive manufacturing device of claim 1, wherein each of the three pumping arrangements comprises a progressive cavity pump, each one of the progressive cavity pumps fluidly coupled with a source of the respective printable component.

3. The additive manufacturing device of claim 1, wherein at least two of the printable components dispensed by at least two of the at least three pumping arrangements comprise a coreactive component;
wherein each of the coreactive components reacts with one another under ambient conditions during the additive manufacturing process.

4. The additive manufacturing device of claim 1, wherein each of the at least three pumping arrangements dispenses a different printable component.

5. The additive manufacturing device of claim 1, wherein the at least three pumping arrangements comprise five pumping arrangements.

6. The additive manufacturing device of claim 4, wherein each of the different printable components comprise a first printable coreactive component, a second printable coreactive component, a third printable coreactive component, and a fourth printable coreactive component, and
the first printable coreactive component and the second printable coreactive component react to form a first coreactive composition, and the third printable coreactive component and the fourth printable coreactive component react to form a second coreactive composition, different than the first coreactive composition.

7. The additive manufacturing device of claim 6, wherein a first pumping arrangement discharges the first printable coreactive component in conjunction with the second pumping arrangement that discharges the second printable coreactive component; and
wherein a third pumping arrangement discharges the third printable coreactive component in conjunction with a fourth pumping arrangement that discharges the fourth printable coreactive component.

8. The additive manufacturing device of claim 1, wherein one of the printable components discharged by the at least three pumping arrangements comprises a flush media.

9. The additive manufacturing device of claim 8, wherein the flush media is discharged into the mixing arrangement and discharges residual one or more printable components present in the mixing arrangement.

10. A three-dimensional object additively manufactured by the additive manufacturing device of claim 1.

11. A mixing arrangement used in an additive manufacturing process, the mixing arrangement comprising:
a mixing volume;
at least three passageways fluidly coupled with the mixing volume, wherein each of the at least three passageways conveys a printable composition into the mixing volume; and
a mechanical mixing device, and
wherein at least two of the printable compositions conveyed by the at least three passageways comprise printable coreactive components that react and cure under ambient conditions, and during the additive manufacturing process, each of the printable coreactive components are substantially simultaneously conveyed into the mixing arrangement and are mixed by the mixing device prior to being discharged from the mixing arrangement.

12. The mixing arrangement of claim 11, wherein the at least three passageways comprise five passageways.

13. The mixing arrangement of claim 12, wherein four of the five passageways convey four printable coreactive components to the mixing volume.

14. The mixing arrangement of either of claim 11, wherein one of the passageways conveys a non-printable coreactive component.

15. The mixing arrangement of claim 11, wherein the five passageways convey five printable coreactive components to the mixing volume, each of the five printable coreactive components comprising the same coreactive composition.

16. A three-dimensional object additively manufactured by the additive manufacturing device of claim 11.

17. A method of additive manufacturing comprising:
combining a first printable coreactive component and a second printable coreactive component in a mixing arrangement including a mechanical mixer, the first printable coreactive component and the second printable coreactive component reacting to form a first printable composition;
extruding the first printable composition from the mixing arrangement through a print nozzle;
flushing the print nozzle with a non-coreactive component;
combining a third printable coreactive component and a fourth printable coreactive component in the mixing arrangement including the mechanical mixer, the third printable coreactive component and the fourth printable coreactive component reacting to form a second printable composition; and
extruding the second printable composition through the print nozzle.

18. A three-dimensional object additively manufactured by the additive manufacturing method of claim 17.

19. A method of additive manufacturing comprising:
combining a first printable coreactive component and a second printable coreactive component in a mixing arrangement including a mechanical mixer, the first printable coreactive component and the second printable coreactive component reacting to form a first printable composition;
extruding the first printable composition from the mixing arrangement through a print nozzle;
combining the first printable coreactive component and a third printable coreactive component in the mixing arrangement including the mechanical mixer, the first printable coreactive component and the third printable coreactive component reacting to form a second printable composition, the second printable composition sharing a coreactive chemistry with the first printable composition; and
extruding the second printable composition through the print nozzle.

20. A three-dimensional object additively manufactured by the additive manufacturing method of claim 19.
